(19) United States
(12) Patent Application Publication
(10) Pub. No.: US 2009/0190280 A1
(43) Pub. Date: Jul. 30, 2009

(54) Current limiter circuit and motor drive circuit

(76) Inventors: Mitsuaki Daio, Kyoto (JP); Daiki Yanagishima, Kyoto (JP)

Correspondence Address: MATTINGLY & MALUR, P.C., 1800 DIAGONAL ROAD, SUITE 370, ALEXANDRIA, VA, 22314, US

(21) Appl. No.: 10/585,340

(22) PCT Filed: Jan. 7, 2005
(86) PCT No.: PCT/JP05/00117

§ 371 Date: Jul. 6, 2006

(30) Foreign Application Priority Data
Jan. 9, 2004 (JP) 2004-003841

(51) Int. Cl. H02H 3/00

(52) U.S. Cl. 361/98

(57) ABSTRACT

A current limiter circuit in an IC having a power transistor and an output current detection circuit connected in series with the power transistor. A comparator, a first reference voltage generator circuit and a second reference voltage generator circuit are also included in the current limiter circuit. The comparator generates a control signal for stopping a drive of the power transistor for a predetermined time. The comparator generates the control signal according to a detection signal obtained by the output current detection circuit and a second reference voltage obtained by the second reference voltage generator circuit when the output current of the power transistor reaches a predetermined value larger than the predetermined limit value. The first reference voltage generator circuit is provided externally of the IC and the second reference voltage generator circuit is included within the IC.

### TECHNICAL FIELD

The present invention relates to a current limiter circuit and a motor drive circuit and, in particular, the present invention relates to a current limiter circuit capable of preventing over current when an external reference voltage generator circuit, which detects a standard current value (limited current value), malfunctions in a stepping motor driver IC of unipolar (half wave) drive and protecting power transistor s so that the driver IC can be continuously used.

### BACKGROUND ART

In a stepping motor driver (pulse motor driver) of unipolar drive, a gear-shaped rotor is rotated by a predetermined angle by sequentially exciting a stator of the stepping motor by a single phase drive, a single phase-two phase drive or a two phase drive, etc.

The driver for supplying drive current for exciting the stator sequentially includes coils (exciting coils), which are provided on the stator and connected to a power source line, and power transistors (output stage transistors), which are provided for respective phases and connected in series with the respective coils. The stepping motor is driven by sequentially exciting the stator by ON/OFF control of the power transistors with a predetermined timing.

When the power transistor of a certain phase is turned ON, the drive current is sequentially increased in the ON period due to transient phenomenon having a predetermined time constant, which is determined by inductance of the exciting coils in the same phase and impedance of the power transistors in the same phase, etc. In order to limit the increase of drive current to a predetermined value, the power transistor is turned ON and, after a predetermined time lapses from the turning ON, turned OFF so that an over current does not flow through the power transistor. In order to realize the scheme, the power transistor is driven such that each phase is chopped by logical pulses of HIGH level “H” and LOW level “L”.

As an example of such pulse drive control, a three phase motor driver, which is chopper-controlled by setting an ON period by a timer circuit, and a power transistor protective circuit for integrated gate bipolar transistors (IDBTs) of the three phase motor driver are well known (Patent Reference 1).

As described in Patent Reference 1 (JPH11-112313A), an over-current protective circuit for such kind of driver is constructed with a current detector circuit for detecting an output current of the power transistor and an over-current detective circuit for stopping a drive of a power transistor. The current detection circuit is usually provided in series with the power transistor. The over-current detection circuit is activated in response to a detection signal from the current detection circuit, which is obtained when the output current of an output stage power transistor becomes larger than the predetermined value, to limit the output current.

Patent Reference 1: JPH11-112313A

### DISCLOSURE OF THE INVENTION

### Problems that the Invention is to Solve

In general, a comparator compares a voltage signal from the current detector circuit with a reference voltage and, when the voltage signal exceeds the reference voltage, a current limiter circuit stops the drive of the power transistor. When a circuit, which generates the reference voltage, malfunctions, the current limiter circuit does not work and the power transistor may be broken. Therefore, an over-current protective circuit is required separately.

The reference voltage generator circuit for detecting a rated current (limit current value) by means of the current limiting circuit is provided externally of the driver IC. This is because the voltage for detecting the rated current value varies correspondingly to variation of the characteristics of power transistor and, so, it is necessary to regulate the limit current to a value inconformity with a design specification by regulating the voltage value by means of the externally provided reference voltage generator circuit.

Therefore, defective connection of not the circuits within the driver IC but the circuits provided externally of the driver IC tends to occur. When the reference voltage input terminal becomes open by such defective connection, the current limiting circuit does not work and the power transistor becomes ON. The over-current protective circuit provided separately may detect an over-current of the output current, which flows when the power transistor is ON. However, the over-current protective circuit can not be continuously used as the driver since the operation of the driver IC is stopped. Particularly, in the driver of such as the motor drive circuit, it does not work as the driver due to a mere malfunction of the circuit for generating the reference voltage and the motor also does not work. Therefore, there is a problem that a whole system or device may become useless.

The present invention is intended to solve the problem of the prior art and an object of the present invention is to provide a current limiting circuit or a motor drive circuit, which protects a power transistor by preventing over-current from occurring and can be continuously used as a driver IC, when an externally provided reference voltage generator circuit for detecting a rated current malfunctions.

### Means for Solving the Problems

In order to achieve the above object, a current limiting circuit or a motor drive circuit according to the present invention includes an output current detector circuit connected in series with each power transistor, a comparator, a first reference voltage generator circuit and a second reference voltage generator circuit. When an output current of the power transistor becomes a predetermined limit value, the comparator generates a control signal for stopping a drive of the power transistor for a predetermined period on the basis of a detection signal obtained by the output current detection circuit and a first reference voltage obtained by the first reference voltage generator circuit and, when the output current of the power transistor becomes a predetermined value exceeding the predetermined limit value, the comparator generates a control signal on the basis of a detection signal of the output current detector circuit and a second reference voltage of the second reference voltage generator circuit. The first reference voltage generator circuit is provided externally of the driver IC and the second reference voltage generator is provided within the driver IC.

### Advantage of the Invention

In the present invention, the second reference voltage generator circuit is provided within the driver IC. Therefore, when the first reference voltage generator circuit for detecting the rated current value malfunctions, the second reference voltage generator circuit limits the current to prevent over-current from flowing and to protect the power transistor.

There may be substantially no defective connection in the second reference current generator circuit provided within the driver IC. Therefore, the driver IC can be reliably protected. By setting the above mentioned predetermined value to a level, which is slightly higher than the first reference voltage and does not cause any problem in continuously operating as the driver IC, the operation of the driver IC has no adverse effect.

Therefore, it becomes possible to continuously use the IC as the driver even when the externally provided first reference voltage generator circuit is not exchanged.

Incidentally, since the voltage to be generated by the first reference voltage generator circuit can be easily determined, provided that the voltage to be generated through a connecting terminal thereof can be checked, it is easy to recover the normal operating state by exchanging the first reference voltage generator circuit.

In such case, the voltage to be generated by the first reference voltage generator circuit can be easily obtained from the voltage of the second reference voltage generator circuit.

The rated current value corresponds to a limit current (design value) for not the over-current protection but limitation of the current below a certain current when the motor drive circuit is chopper-driven. The voltage of the second reference voltage generator circuit is used for both the over-current protection and the current limitation. The over-current protective circuit is primarily provided for preventing the IC from being broken. However, by setting the voltage of the second reference voltage generator circuit close to the limit current caused by the voltage of the first reference voltage generator circuit, the over-current protection circuit works as a current limiter circuit when the current limiting operation by the voltage of the first reference voltage generator circuit becomes impossible.

Incidentally, the voltage close to the limit current may be higher than an upper limit value of a voltage variation of the externally provided first reference voltage generator circuit and equal to or lower than the maximum rated current of the power transistor.

That is, the limit current caused by the voltage of the second reference voltage generator circuit exceeds the rated current and is in a range in which there is no problem even when the power transistor continues the motor drive operation. For example, the limit current caused by the voltage of the second reference voltage generator circuit is preferably higher by 3% to 10% of the current for limiting the current.

As a result, the driver or the motor is not influenced by only malfunction of the reference voltage generator circuit and it is possible to prevent the mechanism or the whole device from being damaged.

### BEST MODE FOR CARRYING OUT OF THE INVENTION

FIG. 1 is a block circuit diagram of a single phase drive circuit of a unipolar drive stepping motor driver using a current limiter circuit according to an embodiment of the present invention and FIG. 2 is a circuit diagram of a comparator of the current limiter circuit.

In FIG. 1, a unipolar drive stepping motor driver IC 10 includes current output circuits 1a, 1b, 1c and 1d, which are connected to exciting coils 11a, 11b, 11c and 11d of a stepping motor 11, respectively. Flywheel diodes D are connected in parallel to the exciting coils 11a to 11d, respectively.

The current output circuits 1a to 1d have identical circuit constructions and, therefore, only the current output circuit 1a is shown and described in detail. Incidentally, a reference numeral 12 depicts a power source.

The current output circuit 1a includes an N channel MOSFET power transistor Tr. A drain of the power transistor Tr is connected to an output terminal 2a and an exciting current is outputted to the output terminal 2a. A source of the power transistor Tr is connected to a resistor Rs for detecting an output current. The resistor Rs is provided externally of the stepping motor driver IC and grounds a terminal 2e. An output current of the output terminal 2a is a sink current from the exciting coil 11a. The current limiter circuit 3 includes a doubling (×2) amplifier 4, a comparator 5, a first voltage generator circuit 6a and a second voltage generator circuit 6b.

The amplifier 4 is connected between the terminal 2e and a (−) input terminal of the comparator 5. The reference voltage generator circuit 6a is provided externally of the stepping motor driver IC and connected to a (+) input of the comparator 5 through a terminal 2f. Thus, the reference voltage generator circuit 6a functions to apply a reference voltage VREF to the (+) input of the comparator 5. On the other hand, the reference voltage generator circuit 6b is provided within the stepping motor driver IC and connected to other (+) input of the comparator 5 to apply a reference voltage VR (VR>VREF) to the (+) input of the comparator 5.

Incidentally, the reference voltage VR is slightly higher than the reference voltage VREF to avoid problem when the stepping motor driver IC is operated with this reference voltage VR.

The reference voltage VR is close to a voltage corresponding to the limit current value caused by the reference voltage VREF. The voltage VR is determined such that the current is limited to a value larger by 3% to 10% of the designed limiting current. It is enough that the voltage close to the limit current may be higher than an upper limit value of a variation of the reference voltage VREF of the externally provided first reference voltage generator circuit 6a and equal to or lower than the maximum rated current of the power transistor.

When the output current of the power transistor Tr increases and a drive current (output current), with which a terminal voltage Vs of the resistor Rs for detecting the output current exceeds the reference voltage VREF, is generated in the power transistor Tr, that is, when the output current becomes the predetermined limit value (limit current value), the output of the comparator 5 is changed from “H” to “L”, resulting in a detection pulse S (“L” is significant). The detection pulse S is supplied to an internal delay circuit 7 and a delayed detection pulse S is inputted to a clock terminal CLK of an RS-flip-flop (data latch circuit) 8 as a fall-trigger signal. At this time, 1-bit data of the detection pulse S (“L”), which is not delayed, is supplied to a D terminal of the RS-flip-flop. Therefore, the 1-bit data is latched by the delayed trigger signal.

As a result, the output of the RS-flip-flop 8 becomes “L”, which is supplied to an AND gate 9.

A phase exciting signal G (“H”) from a phase exciting signal generator circuit (not shown) is supplied to the AND gate 9. Thus, the AND gate 9 is closed by the output (“L”) of the RS-flip-flop 8. As a result, the phase exciting signal G (“H”) supplied to a gate of the power transistor Tr is blocked and the power transistor Tr becomes OFF. When the power transistor Tr becomes OFF, the voltage Vs becomes ground potential and the output (detection pulse S) of the comparator 5 is changed from “L” to “H”, so that the detection pulse S is ended.

Therefore, the detection pulse S operates as a control signal for turning the power transistor Tr OFF.

On the other hand, the detection pulse S (“L”) is also supplied to a timer circuit 7a, which generates a chopping pulse to the RS-flip-flop 8 after a constant time from the input of the detection signal. That is, after the constant time from a time when the power transistor Tr is turned OFF, the chopping pulse P (“H”) is supplied to the internal delay circuit 17 through the timer circuit 7a and an inverter 7b. Further, the chopping pulse P (“H”) is supplied to the D terminal of the RS-flip-flop 8 without delay.

The internal delay circuit 7 generates a trigger pulse, which falls when the chopping pulse P rises. Therefore, “H”, that is, “1” is latched by the RS-flip-flop 8 during the chopping pulse P is “H”, so that the phase exciting pulse G having a quiescent time corresponding to a time count of the timer circuit 7a is generated at a Q output of the RS flip-flop 8. As a result, the AND gate 9 is opened. Thus, the AND condition is established when the phase exciting signal G is “H” and the power transistor Tr supplies an increasing drive current to the exciting coil 11a. When the amount of the drive current reaches the predetermined limit value (limit current value), the output of the comparator 5 is changed from “H” to “L” and the detection pulse S is generated. Thus, the power transistor Tr is turned OFF again.

By repeating this operation, the output current of the power transistor Tr is chopped during the drive period in which the phase exciting signal G (“H”) is supplied to the gate of the transistor Tr and the drive current flows to the exciting coil 11a correspondingly to the timing of the generation of the phase exciting signal G.

Incidentally, the timer circuit 7a functions to change the chopping pulse P, which is in H level, to L level for a constant time. When there is no detection pulse S supplied, the timer circuit 7a generates the chopping pulse P in “H” level to thereby set “1” in the RS-flip-flop 8 and hold the AND gate 9 opened. The AND condition is established when the phase exciting signal G (“H”) is generated and the power transistor Tr supplies the drive current to the exciting coil 11a. The above mentioned operation is started correspondingly to the generation of the phase exciting signal G.

Thus, the current limiter circuit 3 limits the output current of the power transistor Tr by blocking the drive current when the voltage Vs of the resistor Rs at a terminal 2e exceeds the reference voltage VREF, that is, when the output current of the power transistor Tr becomes the rated current value. In this point, the current limiter circuit 3 serves as both the current limiter and the over-current protective circuit.

It is assumed that the reference voltage VREF does not appear at the terminal 2f by malfunction of the reference voltage generator circuit 6a or defective connection of the terminal 2f.

In such case, the output current of the power transistor Tr increases and the voltage Vs exceeds the reference voltage VREF. When the output current, with which the voltage Vs exceeds the reference voltage VR, is generated in the power transistor Tr, that is, when the output current becomes a predetermined value equal to or larger than the predetermined limit value, the comparator 5 outputs the detection pulse S (“L” is significant) which is changed from “H” to “L”.

That is, a comparative reference voltage of the comparator 5 is changed from the reference voltage VREF of the reference voltage generator circuit 6a to the reference voltage VR of the reference voltage generator circuit 6b and the above mentioned operation is continuously performed. Therefore, the operation of the stepping motor driver IC 10 as the driver can be continued.

FIG. 2 is a circuit diagram showing the comparator 5. The comparator 5 includes a differential amplifier 50 composed of PNP transistors Q1 and Q2. Emitters of PNP transistors Q3 and Q4 are connected in parallel to a base of the transistor Q1. Collectors of the transistors Q3 and Q4 are grounded.

An emitter of a PNP transistor Q5 is connected to a base of the transistor Q2 and a collector of the PNP transistor Q5 is grounded. A current detection signal from the doubling (×2) amplifier 4 is supplied to the base of the PNP transistor Q5.

The reference voltage generator circuit 6a is provided between the base of the transistor Q3 and the terminal 2f and the reference voltage generator circuit 6b is provided between the base of the transistor Q4 and ground (GND).

Reference numerals 51 to 53 are current sources provided between the emitters of the respective transistors Q1 to Q5 and a power source line VDD. NPN transistors Q6 and Q7 constituting a current mirror circuit are provided downstream side of the transistors Q1 and Q2 as an active load circuit of the differential amplifier 50. Emitters of the transistors Q6 and Q7 are grounded.

NPN transistors Q8 and Q9 are output stage transistors having emitters grounded. A collector of the transistor Q8 is connected to the power source line +VDD through a current source 54 and an output of the collector of the transistor Q6 is supplied to a base of the transistor Q8. A collector of the transistor Q9 is connected to the power source line +VDD through a load resistor R. A base of the transistor Q9 receives the collector of the transistor QB to generate the detection pulse P.

The voltage to be generated by the first reference voltage generator circuit 6a can be easily known by checking it through the terminal 2f. Therefore, when the first reference voltage generator circuit 6a malfunctions and is replaced by another first reference voltage generator circuit, it is easily possible to recover the normal operation.

The voltage to be generated by the first reference voltage generator circuit 6a may be equal to the voltage of the second reference voltage generator circuit 6b or lower than the voltage of the second reference voltage generator circuit 6b by a predetermined value. Therefore, it is better to employ a circuit construction in which the voltage of the second reference voltage generator circuit 6b is outputted to the connecting terminal (terminal 2f) of the first reference voltage generator circuit 6a. The terminal 2f in FIG. 2 is used in such circuit construction. When the voltage of the second reference voltage generator circuit 6b is higher than the reference voltage VREF of the first reference voltage generator circuit 6a by 1 Vf (forward dropdown voltage between the base and the emitter) or more, the transistor Q4 is kept OFF so long as the first reference voltage generator circuit 6a is connected to the terminal 2f.

Assuming that the predetermined limit value of the output current of the power transistor Tr, which is limited by the reference voltage VREF of the reference voltage generator circuit 6a, is 2.6 A, the output current of the power transistor, which is limited by the voltage VR of the reference voltage generator circuit 6b, is set to about 2.7 A (=2.6×1.038), which is not detrimental for the circuit operation. There is no need of changing the circuit relation as the current limiter circuit. Incidentally, the maximum rated current of the power transistor Tr is 3.0 A (>2.6 A).

As a result, when the reference voltage generator circuit 6a malfunctions and the reference voltage VREF can not be applied to the comparator 5, the voltage VR slightly higher than the reference voltage VREF is set so that the operation of the driver IC is kept and can be continuously operated as the driver.

In the described embodiment, the comparator 5 is provided in each of the current output circuits 1a to 1d. However, it may be possible that a plurality of power output circuits commonly use a current output circuit. In such case, it is possible to use 2 comparators by making the output current detection resistors Rs of the comparators 5 of the current output circuits 1a and 1b common and the output current detection resistors Rs of the comparators 5 of the current output circuits 1c and 1d common.

Although the power transistor Tr is the MOSFET in this embodiment, a bipolar transistor may be used.

Further, although, in the embodiment, the motor drive circuit of the unipolar drive stepping motor driver IC is described, it is possible to use a push-pull drive circuit as the output circuit of the power transistor and to apply this invention to a bipolar drive (positive and negative phase drive) stepping motor driver IC.

### INDUSTRIAL APPLICABILITY

Although, in the described embodiment, the power transistor is ON/OFF controlled by the internal delay circuit 7, the RS-flip-flop (data latch circuit) 8, the AND gate 9 and the OFF timer circuit 7a, these circuits are not always necessary so long as the power transistor Tr is OFFed.

Further, although, in this embodiment, the comparator 5 has two (+) input terminals, it is possible to constitute the comparator 5 with two parallel comparators. Alternatively, it is possible to provide two parallel comparators each having a (+) input and a (−) input.

Although the present invention has been described with reference to the stepping motor driver circuit, the present invention can be applied to any drive circuit including a current limiter circuit or an over-current protective circuit for limiting a drive current by turning a power transistor OFF with a rated current value.

### BRIEF DESCRIPTION OF THE DRAWINGS

FIG. 1 is a block diagram showing a unipolar drive circuit of a stepping motor driver having a current limiter circuit according to an embodiment of the present invention.

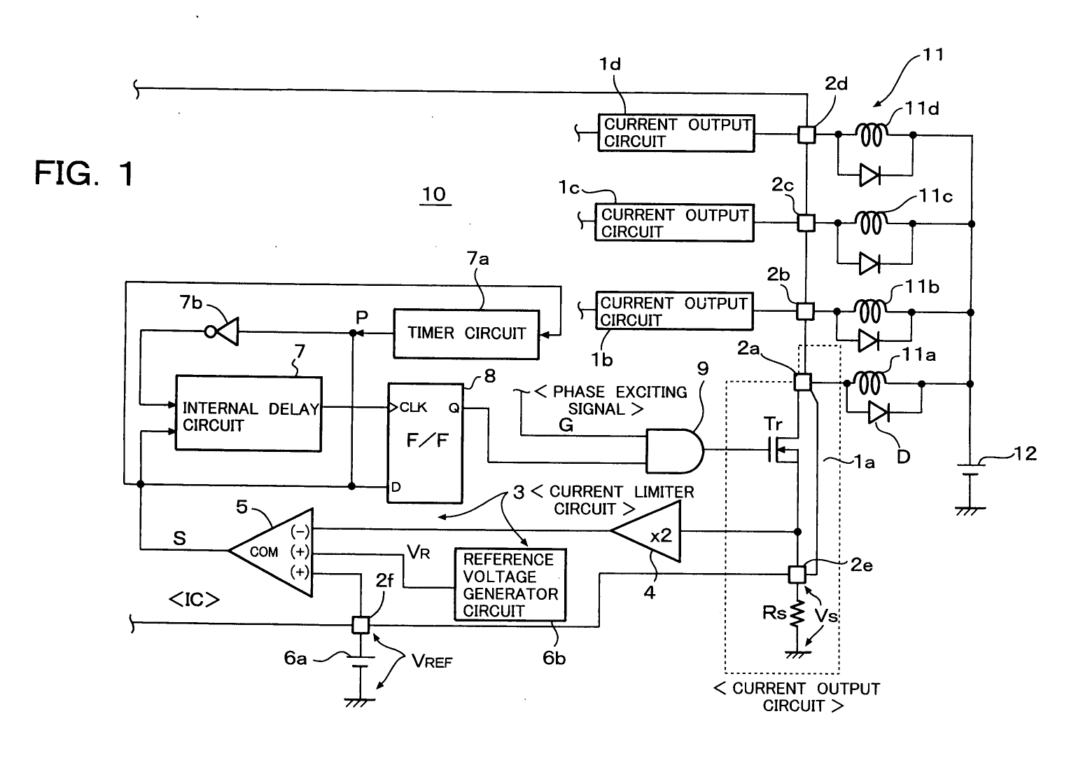

FIG. 2 is a circuit diagram of a comparator in the current limiter circuit.

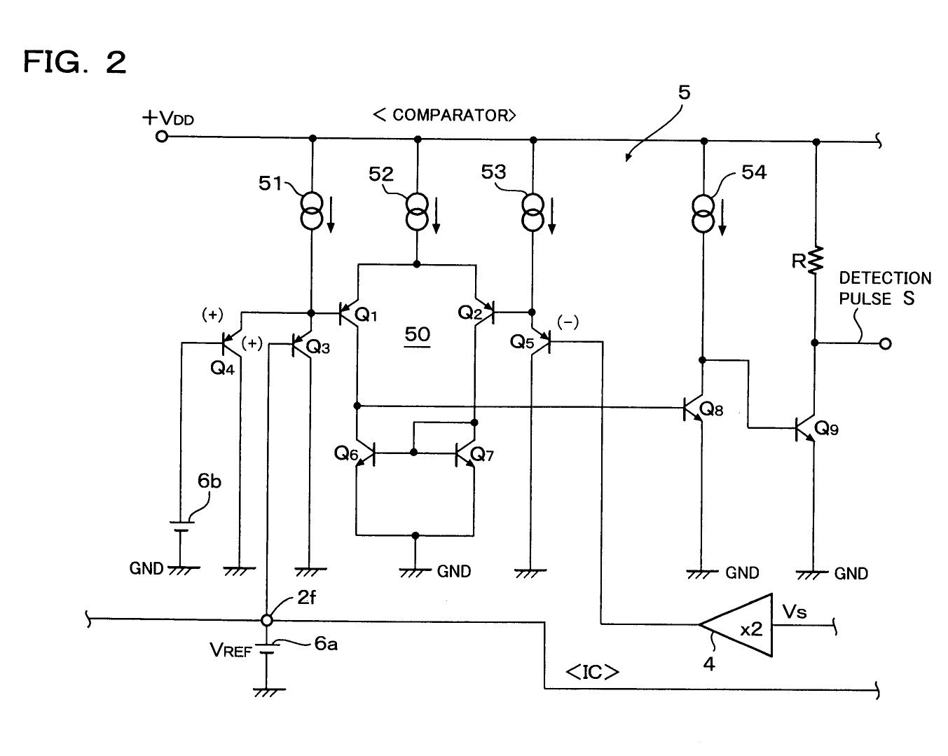

### DESCRIPTION OF REFERENCE NUMERALS AND SIGNS

1a, 1b, 1c, 1d current output circuit
2a, 2b, 2c, 2d . . . output terminal
3 . . . current limiter circuit
4 . . . ×2 amplifier
5 . . . comparator
6a . . . first reference voltage generator circuit
6b . . . second reference voltage generator circuit
7 . . . internal delay circuit
7a . . . timer circuit
7b . . . inverter
8 . . . PS-flip-flop (data latch circuit)
9 . . . AND gate
10 . . . stepping motor driver IC
11a, 11b, 11c, 11d . . . exciting coil
12 . . . power source
Rs . . . resistor
Tr . . . N channel MOSFET power transistor
Q1 . . . Q9 . . . bipolar transistor
D . . . flywheel diode

1. A current limiter circuit in an IC including a power transistor and an output current detection circuit, said current limiter circuit comprising:
a comparator;
a first reference voltage generator circuit; and
a second reference voltage generator circuit,
wherein said output current detection circuit connected in series with said power transistor, said comparator generates a control signal for stopping a drive of said power transistor for a predetermined time according to a detection signal obtained by said output current detection circuit when an output current of said power transistor reaches a predetermined limit value and according to a first reference voltage obtained by said first reference voltage generator circuit, and said comparator generates the control signal according to a detection signal obtained by said output current detection circuit when the output current of said power transistor reaches a predetermined value larger than the predetermined limit value and according to a second reference voltage obtained by said second reference voltage generator circuit, said first reference voltage generator circuit is proved externally of said IC and said second reference voltage generator circuit is included within said IC.

2. The current limiter circuit as claimed in claim 1, wherein said second reference voltage is set within a range in which said power transistor can continuously operate as a driver.

3. The current limiter circuit as claimed in claim 2, wherein the output current of said power transistor is outputted as a drive current of a motor.

4. The current limiter circuit as claimed in claim 3, wherein the output current of said power transistor is a sink drive current from an output terminal to which the output current of said power transistor is outputted.

5. The current limiter circuit as claimed in claim 4, wherein the predetermined value is in a range larger than the predetermined limit value by 3% to 10% of the predetermined limit value, said output current detector circuit includes a resistor externally provided through said IC and the detection signal is a terminal voltage generated by said resistor.

6. The current limiter as claimed in claim 5, further comprising a chopping pulse generator circuit and a timer circuit, wherein the predetermined time period is a constant time period, said timer circuit clocks the constant time period in response to the control signal, said chopping pulse generator circuit generates pulse with an interval of the constant time period set by said timer circuit and said power transistor is ON/OFF controlled according to the pulses.

7. A motor drive circuit for driving a motor by the output current of said power transistor of said IC including said current limiter circuit claimed in claim 1.

8. The motor drive circuit as claimed in claim 7, wherein said motor is a stepping motor.
